(19) United States
(12) Patent Application Publication
(10) Pub. No.: US 2025/0199477 A1
(43) Pub. Date: Jun. 19, 2025

(54) STUD-HOLDER FOR A HOROLOGICAL REGULATING MEMBER PROVIDED WITH MEANS FOR ADJUSTING THE RATE AND/OR ISOCHRONISM

(71) Applicant: The Swatch Group Research and Development Ltd, Marin (CH)

(72) Inventors: Mohammad Hussein KAHROBAIYAN, Boudevilliers (CH); Gianni DI DOMENICO, Neuchâtel (CH)

(73) Assignee: The Swatch Group Research and Development Ltd, Marin (CH)

(21) Appl. No.: 18/934,382

(22) Filed: Nov. 1, 2024

(30) Foreign Application Priority Data
Dec. 19, 2023 (EP) 23218148.7

(51) Int. Cl. G04B 18/06; G04B 17/06; G04B 17/32

(52) U.S. Cl. CPC G04B 18/06; G04B 17/06; G04B 17/32

(57) ABSTRACT

A stud-holder for a regulating member (150) of a horological movement, the regulating member (150) including an inertial mass, for example a balance (41), a balance spring (44) including a strip wound about itself in several turns, and a balance cock (42), the stud-holder (120) including a main body (2) intended to be mounted on the balance cock (42), and a secondary body (3) arranged at a distance from the main body (2) and configured to suspend the balance spring (44), the regulating member (150) including a flexible element (5) connecting the main body (2) to the secondary body (3), the stud-holder (120) including prestressing device (6) for applying a variable force or torque to the flexible element (5) in order to adjust the rate and/or isochronism slope of the regulating member (150).

### CROSS REFERENCE TO RELATED APPLICATION

This application claims priority to European Patent Application No. 23218148.7 filed Dec. 19, 2023, the entire contents of which are incorporated herein by reference.

### TECHNICAL FIELD OF THE INVENTION

The invention relates to the field of watchmaking, and more particularly to the field of mechanical watchmaking, where the regulation of the driving energy is provided by a regulating member.

The invention relates more specifically to a stud-holder for a horological regulating member provided with means for adjusting the rate and/or isochronism, as well as to a regulating member comprising such a stud-holder, and to a horological movement comprising such a regulating member.

### Technological Background

In most mechanical watches, the energy required to rotate the hands (for example the minute and hour hands) is stored in a barrel and then delivered by a sprung balance system, which comprises a flywheel called a balance, combined with a spring in the form of a spirally wound strip called a balance spring.

An inside end of the balance spring is attached to a staff that rotates as one with the balance; an outside end of the balance spring is attached to a stud mounted on a stud-holder that is itself rigidly connected to a stationary cock.

The rotation of the balance is maintained—and its oscillations counted—by an escapement mechanism comprising a pallet-lever animated by a low-amplitude oscillating motion, provided with two pallets which engage the teeth of an escape wheel. When the escape wheel is engaged in this way, it is caused to rotate in steps, the frequency of which rotation is determined by the frequency of oscillation of the pallet-lever, which is itself set to the frequency of oscillation of the sprung balance.

In a conventional escapement mechanism, the oscillation frequency is around 4 Hz, or approximately 28,800 vibrations per hour (V/h). One of the objectives of good watchmakers is to ensure the isochronism and regularity of the oscillations (or constancy of rate) of the sprung balance.

The rate of the balance spring can be regulated in a known manner by adjusting the active length of the balance spring, defined as the curvilinear length between its inside end and a counting point, located in the vicinity of the outside end of the balance spring and typically defined by a pair of bankings carried by a key mounted on an index system.

In operation, this index system is not able to rotate about the axis of the balance spring. However, its angular position can be fine-tuned by manual intervention, for example by pivoting an eccentric acting like a cam on the index system using a screwdriver.

The assembly comprising the cock, the index system, the key, the stud-holder, the stud, the staff, the balance spring and the balance is commonly referred to as the “regulating member”. Examples of regulating members are given in the international patent WO 2016/192957 and in the European patent EP 2 876 504, both filed by the watch manufacturer ETA.

There are index systems which have a stud-holder to which one end of the balance spring is attached, and where the index system key leaves play to allow the balance spring to move between the two stops. However, the chronometric properties, in particular the anisochronism as a function of amplitude, are very sensitive to play at the index key, and this play is difficult to control precisely.

In some devices, the stops can be adjusted to clamp the balance spring in order to eliminate play, particularly when the balance spring is in operation. In this case, first the rate is regulated by moving the index key, then clamping the balance spring to the key. However, clamping the balance spring to the index key risks stressing it and creating chronometric errors, in particular due to the off-centring of the windings. Moreover, removing the play also changes the rate, and once the balance spring has been clamped, you can no longer move the index key along the balance spring to finish fine-tuning the rate.

Other balance springs have integrated rate adjustment means. In these balance springs, the rate is not regulated by altering the effective length of the balance spring, but by applying a force or torque to a flexible element arranged in series with the balance spring. In this way, the stiffness of the flexible element and consequently of the balance spring as a whole can be modified. Adjusting the stiffness of the balance spring allows the rate of the regulating member to be regulated. Such a balance spring provided with a flexible element is described, for example, in patent applications EP21202213.1 and CH0700385/2021.

In these cases, the usual systems cannot be used, as they are not compatible with the balance spring regulating device. Moreover, as the rate has to be regulated to a very fine degree, it is essential that there is no play between the balance spring and the areas where it interacts with the index assembly. More specifically, if this were not the case, there would be a risk of the rate being altered in the event of an impact, if the balance spring does not reposition itself in exactly the same way after the impact.

To use such a balance spring, an index system has been described in patent applications EP22177059.7 and CH000678/2022. The index system comprises a stud-holder in two parts that can move relative to each other, each element being provided with a stud on which the flexible element is mounted on the one hand, and the prestressing means acting on the flexible element on the other. Thus, by moving the two elements relative to each other, the force or torque applied to the flexible element is modified, in order to adjust the stiffness of the balance spring.

However, the index system is complex to implement, as the movable elements of the stud-holder each perform a rotary motion above the balance spring.

Furthermore, in these patent applications, the balance spring has a particular shape, as the flexible element and the prestressing means are mounted directly on the balance spring, or the balance spring and the adjustment means are made in one piece. As a result, it is not possible to use a conventional balance spring with this index system.

Additionally, there may also be a need to adjust the isochronism slope of the regulating member.

### SUMMARY OF THE INVENTION

The aim of the present invention is to overcome all or some of the above-mentioned drawbacks by providing a stud-holder which is compatible with conventional balance springs, and which can provide the same advantages in terms of precision in adjusting the rate and/or isochronism as a balance spring fitted with adjustment means such as that of the prior art.

To this end, the invention relates to a stud-holder for a regulating member of a horological movement, the regulating member comprising an inertial mass, for example a balance, a balance spring comprising a strip wound about itself in several turns, and a balance cock, the stud-holder comprising a main body intended to be mounted on the balance cock, and a secondary body arranged at a distance from the main body and configured to suspend the balance spring, the regulating member comprising a flexible element connecting the main body to the secondary body.

The invention is characterised in that the stud-holder comprises prestressing means for applying a variable force or torque to the flexible element in order to adjust the rate and/or isochronism slope of the regulating member.

Thanks to the invention, balance springs of a conventional shape can be used, i.e. balance springs without any flexible element mounted or formed directly on the balance spring. More specifically, the flexible element is arranged on the stud-holder, so that the balance spring need only be mounted on the stud-holder to obtain the same advantages as a balance spring equipped with means for adjusting the stiffness of the prior art.

The flexible element and the prestressing means of the stud-holder form means for adjusting the rate and/or isochronism of a regulating member fitted with a balance spring.

By acting on the prestressing means, the force or torque applied to the flexible element is modified, resulting in a change in the stiffness of the assembly comprising the flexible element and the strip. More specifically, the flexible element placed in series with the strip provides additional stiffness to the strip, which is added after the strip. Thus, when the prestressing means apply a variable force or torque to the flexible element, they modify the stiffness of the flexible element and thus of the assembly comprising the strip and the flexible element.

Thus, on the one hand, the stiffness of the flexible element can be adjusted, in order to adjust the rate of the regulating member, and on the other hand, the flexible element allows the secondary body to be rotated relative to the main body, and as a result allows the isochronism slope of the regulating member to be adjusted.

This also avoids the need to manufacture a complex balance spring.

According to a particular embodiment of the invention, the flexible element comprises two crossing flexible blades connecting the main body to the secondary body.

According to a particular embodiment of the invention, the two flexible blades are connected to each other at their intersection.

According to a particular embodiment of the invention, the flexible element comprises two flexible non-crossing blades connecting the main body to the secondary body.

According to a particular embodiment of the invention, the flexible element comprises a flexible neck connecting the main body to the secondary body.

According to a particular embodiment of the invention, the flexible element comprises a flexible blade connecting the main body to the secondary body.

According to a particular embodiment of the invention, the flexible element comprises two substantially parallel flexible blades connecting the main body to the secondary body in order to form a translation stage.

According to a particular embodiment of the invention, the main body comprises an arm to which the flexible element is assembled.

According to a particular embodiment of the invention, the flexible element is stiffer than the strip.

According to a particular embodiment of the invention, the torque or force can be adjusted continuously by the prestressing means.

According to a particular embodiment of the invention, the prestressing means comprise a movable lever arranged to bear against the flexible element.

According to a particular embodiment of the invention, the prestressing means comprise a spring connected to the secondary body and a first movable body for stretching or compressing the spring.

According to a particular embodiment of the invention, the spring comprises a secondary flexible blade.

According to a particular embodiment of the invention, the spring comprises a plurality of tertiary flexible blades connecting the main body to the first movable body.

According to a particular embodiment of the invention, the spring comprises a plurality of quaternary flexible blades connecting the first movable body to a second movable body of the prestressing means.

According to a particular embodiment of the invention, the prestressing means comprise a plurality of rigid sections connected by flexible necks or flexible blades.

The invention further relates to a horological regulating member comprising an inertial mass, for example a balance, a balance spring comprising a strip wound about itself in several turns, a balance cock, and such a stud-holder.

The invention further relates to a horological movement comprising such a horological regulating member.

### BRIEF DESCRIPTION OF THE FIGURES

The purposes, advantages and features of the present invention will become apparent after reading several embodiments, which are provided for purposes of illustration only and not intended to limit the scope of the invention, given with reference to the accompanying drawings, wherein:

FIG. 1 diagrammatically shows a top view of a stud-holder according to a first embodiment of the invention,

FIG. 2 diagrammatically shows a top view of a stud-holder according to a second embodiment of the invention,

FIG. 3 diagrammatically shows a top view of a stud-holder according to a third embodiment of the invention,

FIG. 4 diagrammatically shows a top view of a stud-holder according to a fourth embodiment of the invention,

FIG. 5 diagrammatically shows a top view of a stud-holder according to a fifth embodiment of the invention,

FIG. 6 diagrammatically shows a top view of a stud-holder according to a sixth embodiment of the invention,

FIG. 7 diagrammatically shows a top view of a stud-holder according to a seventh embodiment of the invention,

FIG. 8 diagrammatically shows a perspective view of a stud-holder according to an eighth embodiment of the invention,

FIG. 9 diagrammatically shows a top view of a stud-holder according to a ninth embodiment of the invention,

FIG. 10 diagrammatically shows a top view of a stud-holder according to a tenth embodiment of the invention,

FIG. 11 diagrammatically shows a top view of a stud-holder according to an eleventh embodiment of the invention,

FIG. 12 diagrammatically shows a top view of a stud-holder according to a twelfth embodiment of the invention,

FIG. 13 diagrammatically shows a top view of a stud-holder according to a thirteenth embodiment of the invention,

FIG. 14 diagrammatically shows a top view of a regulating member provided with a stud-holder according to a thirteenth embodiment of the invention,

FIG. 15 diagrammatically shows a top view of a stud-holder according to a fourteenth embodiment of the invention, and

FIG. 16 diagrammatically shows a top view of a stud-holder according to a fifteenth embodiment of the invention.

### DETAILED DESCRIPTION OF THE INVENTION

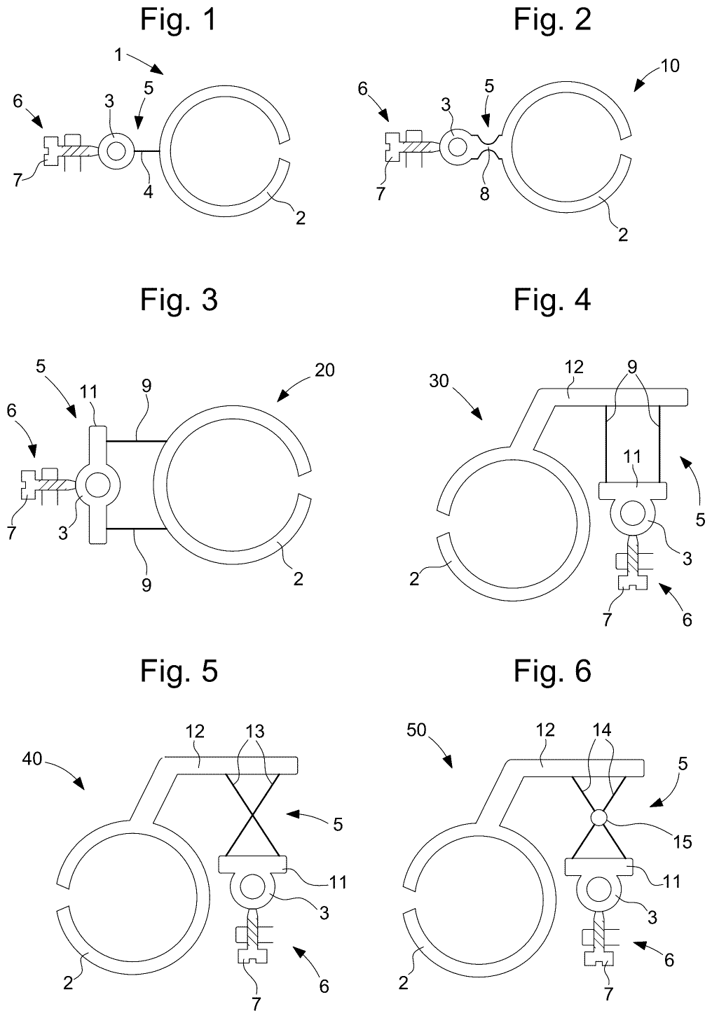

FIGS. 1 to 16 each diagrammatically show a different embodiment of a stud-holder 1, 10, 20, 30, 40, 50, 60, 70, 80, 90, 100, 110, 120, 130, 140 according to the invention. Such a stud-holder 1, 10, 20, 30, 40, 50, 60, 70, 80, 90, 100, 110, 120, 130, 140 is intended to be arranged in a regulating member of a horological movement. The stud-holders 1, 10, 20, 30, 40, 50, 60, 70, 80, 90, 100, 110, 120, 130, 140 preferably extend substantially in the same plane.

The regulating member typically comprises an inertial mass, for example a balance, a balance spring, and a balance cock allowing it to be assembled on a plate of a horological movement.

In particular, the stud-holder 1, 10, 20, 30, 40, 50, 60, 70, 80, 90, 100, 110, 120, 130, 140 has the function of suspending the balance spring extending substantially in one plane. Such a balance spring comprises a flexible strip wound about itself in several turns, the strip having a predefined stiffness.

In FIGS. 1 to 16, the stud-holder 1, 10, 20, 30, 40, 50, 60, 70, 80, 90, 100, 110, 120, 130, 140 comprises a main body 2 intended to be mounted on the balance cock, for example around a bearing holding the staff of the balance. The main body 2 is, for example, ring-shaped, and can be arranged around the bearing.

The stud-holder 1, 10, 20, 30, 40, 50, 60, 70, 80, 90, 100, 110, 120, 130, 140 further comprises a secondary body 3 arranged at a distance from the main body 2. The secondary body 3 includes a recess for inserting and holding a first end of a stud, preferably towards the underside of the balance cock.

Depending on the embodiment, the secondary body 3 has an annular or rectangular shape.

The main body 2 and the secondary body 3 are connected by a flexible element 5, preferably solely thereby. Thus, the stiffness of the flexible element 5 is added to the stiffness of the balance spring. The stiffness of the flexible element 5 is preferably greater than that of the balance spring. Thanks to the deformation of the flexible element 5, the secondary body 3 can be moved relative to the main body.

According to the invention, the stud-holder 1, 10, 20, 30, 40, 50, 60, 70, 80, 90, 100, 110, 120, 130, 140 comprises prestressing means 6 for applying a variable force or torque to the flexible element 5 in order to adjust the rate of the balance spring. Thus, the stiffness of the assembly comprising the balance spring and the flexible element 5 can be adjusted.

The prestressing means 6 preferably allow the flexible element 5 to move translatably or rotatably in the plane of the balance spring, in order to modify the isochronism slope of the regulating member.

Thus, the stiffness of the flexible element 5 can be varied, with the latter deforming very little under the effect of the prestressing means 6, preferably with the balance spring in a rest position. The flexible element 5 deforms to a greater or lesser extent when the prestressing means 6 act on it. Thus, by varying the force or torque supplied by the prestressing means 6, the stiffness of the flexible element 5 is modified.

Preferably, in order to modify the rate without having any effect on the isochronism curve, the end of the strip remains substantially stationary, whatever the adjustment of the prestressing means 6. The force or torque applied to the flexible element 5 does not substantially modify the position of the end of the strip to which the flexible element is connected. Only the flexible element 5 is acted upon in order to modify the stiffness thereof without acting directly on the strip. This provides even greater precision because only one element is used to adjust the stiffness. During oscillation, the end 4 of the strip can be movable.

Moreover, the torque or force is continuously adjustable thanks to the prestressing means 6. In other words, the torque or force is not restricted to isolated values. The stiffness of the flexible element 5 can thus be adjusted with great precision.

In most of the embodiments of the stud-holder 1, 10, 20, 30, 40, 50, 60, 70, 80, 90, 100, 110, 120, 130, 140 described below, the prestressing means 6 are represented by a screw 7, which bears to a greater or lesser degree against the secondary body 3 or against an intermediate structure. However, other prestressing means 6 are evidently possible, such as a lever, a push-piece or an eccentric, for example.

The prestressing means 6 are applied directly to the secondary body 3.

The first embodiment of the stud-holder 1, 10, 20, 30, 40, 50, 60, 70, 80, 90, 100, 110, 120, 130, 140 shown in FIG. 1 describes a flexible element 5 comprising a substantially straight flexible blade 4 connected to the main body 2 and to the secondary body 2. Under the effect of the prestressing means 6, the stiffness of the flexible blade 4 changes.

In the example shown in FIG. 2, the flexible element 5 of the balance spring 1 comprises a neck 8 thinned out of the thickness of the material, the neck 8 being flexible. Thus, by applying a variable force or torque to the secondary body, the stiffness of the neck 8 and thus of the assembly comprising the strip 2 and the flexible element 5 is modified.

In FIG. 3, the flexible element 5 comprises a translation stage. The translation stage comprises at least one flexible blade, in this case two flexible blades 9, and a rigid part 11 comprising the secondary body 3. The flexible blades 9 are joined by one end to the secondary body 3, and by another end to the main body 2. The flexible blades 9 are substantially parallel and are disposed in different rows.

The secondary body 3 is preferably arranged in the middle of the rigid part 11. In the figure, the variable force or torque is applied to the rigid part 11, in the direction of the flexible blades 9. Thanks to the bending of the flexible blades 9, the rigid part 11 can be slightly displaced. The displacement of the rigid part 11 varies the stiffness of the flexible element 5.

In the embodiments of the stud-holders 30, 40, 50, 60, 70 shown in FIGS. 4 to 8, the main body 2 comprises an arm 12 extending substantially tangentially to the ring. The flexible element 5 is connected to the arm. In these embodiments, the force or torque is not directed towards the main body, as in the first embodiments, but towards the arm 12, perpendicularly to the arm 12.

FIG. 4 shows an embodiment wherein the stud-holder 30 comprises a translation stage similar to that of the third embodiment in FIG. 3; however, the translation stage is mounted perpendicularly on the arm 12. The flexible blades 9 of the translation stage are connected to the arm 12 and extend tangentially to the main body 3.

The flexible element 5 of the stud-holder 40 shown in FIG. 5 comprises a pivot with crossing flexible blades, the pivot comprising two crossing flexible blades 13 linked on the one hand to the secondary body 3, and on the other hand to the main body 2. The pivot with crossing flexible blades 13 is arranged so that the flexible blades 13 cross in the extension of the direction in which the variable force or torque is applied to the secondary body 3.

FIG. 6 shows an embodiment of a stud-holder 50 comprising a pivot with crossing flexible blades 14, the pivot comprising two crossing flexible blades 14 joined at their intersection 15. The flexible blades 14 are connected, on the one hand, to the main body 2 and, on the other hand, to the secondary body 3.

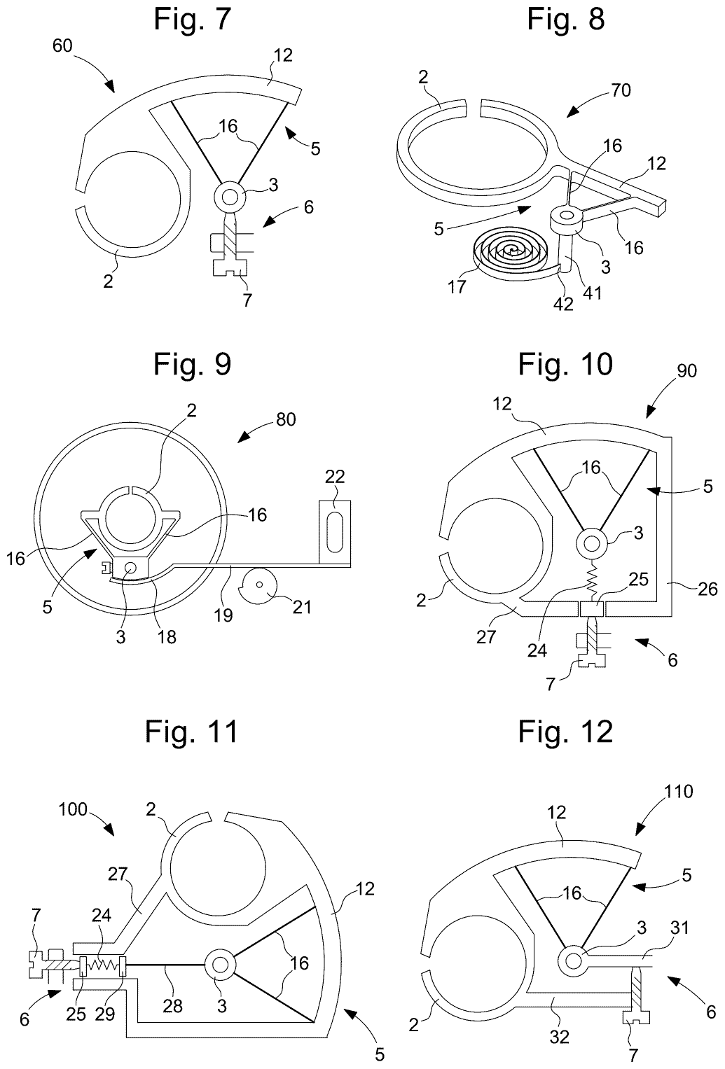

In the embodiments of the stud-holders 60, 70, 80, 90, 100, 110 and 120 shown in FIGS. 7 to 14, the flexible element 5 comprises a pivot with non-crossing flexible blades. The pivot comprises two non-crossing flexible blades 16. The flexible blades 16 are joined, on the one hand, laterally to the main body 2 directly or to a peripheral arm 12 and, on the other hand, to the secondary body 3 by moving towards each other. The centre of rotation of the pivot with non-crossing flexible blades is the virtual crossing point of the blades 16. This centre of rotation is preferably located at the centre of the secondary body 3, or on the staff of the stud 41.

The stud-holder 60 shown in FIGS. 7 and 8 comprises an arm 12 which is oriented differently and to which the pivot with non-crossing blades 16 is attached.

FIG. 8 shows a stud 41 extending below the stud-holder 70 to hold a balance spring 17. The stud 41 comprises a notch 42 at its second end. The notch 42 is configured to retain an outside end of the balance spring 17. The stud 41 and the recess are preferably substantially cylindrical in shape. The stud 41 and the balance spring 17 are assembled, for example, by bonding, brazing, welding, by deformation of metallic glass, or by mechanical fastening.

In the embodiment of the stud-holder 80 shown in FIG. 9, the flexible blades 16 of the flexible element 5 extend on either side of the main body 2, to be connected to tabs connected to the main body 2.

The prestressing means 6 comprise a lever 19 bearing directly against the secondary body 3 at a first end 18, and comprising fastening means 22 at a second end. The prestressing means 6 further include a cam 21 on which the lever 19 rests. Thus, by actuating the cam 21, the lever 19 bears to a greater or lesser degree on the secondary body 3 in order to modify the stiffness of the flexible element 5. The blades 16 preferably cross at the first end 18.

The prestressing means 6 of the stud-holder 90 in the embodiment shown in FIG. 10 comprise a spring 24 and a movable body 25. The spring 24 is joined to the secondary body 3 on the one hand, and to the movable body 25 on the other. Thus, by moving the movable body 25, the spring 24 transmits a variable force or torque to the secondary body 3 in order to adjust the stiffness of the flexible element 5.

The embodiment of the stud-holder 100 shown in FIG. 11 is an alternative embodiment to that shown in FIG. 10, wherein a secondary flexible blade 28 is arranged between the spring 24 and the secondary body 3, in the continuation of the spring 24.

To this end, the prestressing means 6 are provided with a second movable body 29 to which the spring 24 is connected on one side, and the secondary flexible blade 28 on the other side. The secondary flexible blade 28 is connected to the second movable body 29 and to the secondary body 3. By acting on the first movable body 25, the prestressing means 6 modify the variable force or torque acting on the secondary body 3 via the second body 29 and via the secondary flexible blade 28.

In the stud-holders 90, 100, 110 shown in FIGS. 10 to 12, the main body 2 comprises a second arm 27, 32 extending from the main body 2 to form, together with the first arm 12, a guide volume for the first movable body 25.

In FIG. 12, the secondary body 3 of the stud-holder 110 comprises a third arm 31 extending laterally from the secondary body 3. The prestressing means 6 bear to a greater or lesser degree against the first arm 12. The second arm 32 and the third arm 31 are substantially parallel when the stud-holder 110 is in the rest position. The second arm 32 in this case comprises the screw of the prestressing means 6, which bears against the third arm 31, which is offset relative to the secondary body 3.

Thus, when the screw of the prestressing means 6 bears against the third arm 31, the third arm 31 rotates about a centre of rotation located at the intersection of the non-crossing blades 16, and rotates the secondary body 3. The ends of the non-crossing blades 16 connected to the secondary body 3 move, so that the stiffness between the non-crossing blades 16 is substantially altered. This difference in stiffness between the two non-crossing blades 16 makes it possible to modify the isochronism slope of the regulating member.

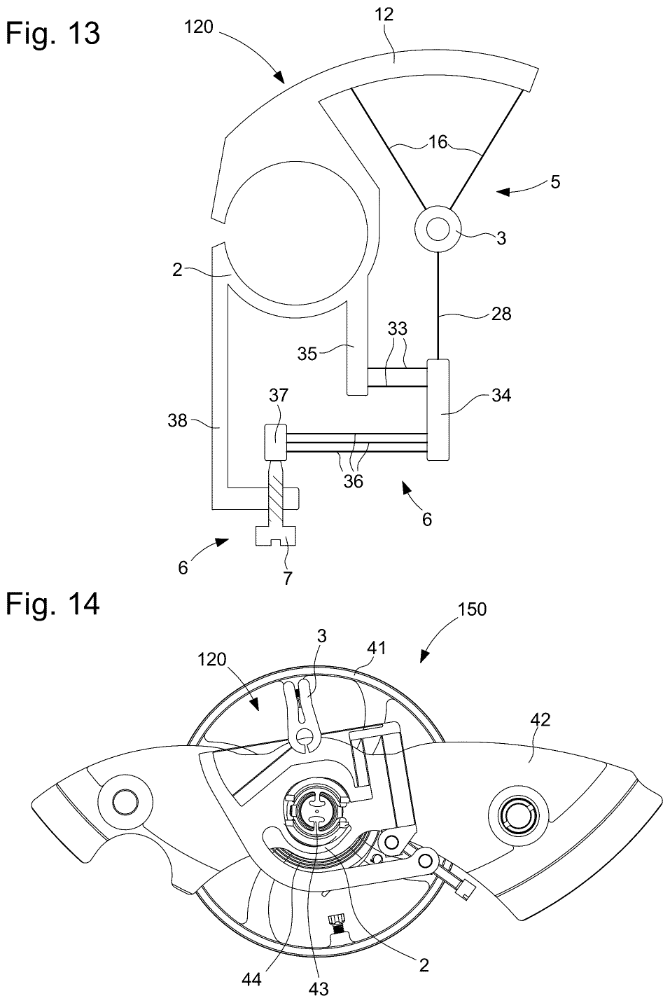

The embodiment of the stud-holder 120 shown in FIGS. 13 and 14 comprises prestressing means 6 provided with a spring formed by a flexible blade guide. A secondary flexible blade 28 connects the secondary body 3 to a first elongated rigid body 34 extending in the continuation of the secondary flexible blade 28.

The prestressing means 6 comprise a second rigid body 37, and tertiary blades 36, in this case three blades, connecting the two rigid bodies 34, 37. The two rigid bodies 34, 37 are movable and have segments that are substantially parallel in pairs when the prestressing means 6 are in the rest position. The tertiary blades 36 are substantially perpendicular to the secondary blade 28 when the prestressing means 6 are in the rest position.

The prestressing means 6 further comprise two quaternary blades 33 connecting the first body 34 to a third arm 35 extending from the main body 2. The third arm is substantially parallel and oriented the same way as the second arm.

The quaternary blades 33 are substantially parallel to the tertiary blades 36 and arranged on the same side of the second rigid body 37. By applying a variable force or torque to the second rigid body 37, the prestressing means 6 vary the stiffness of the flexible element 5 in order to modify the rate of the regulating member. The prestressing means 6 are arranged in the axis of the flexible element 5.

In FIG. 14, a folded alternative embodiment of the stud-holder 120 of the embodiment shown in FIG. 13 is mounted on a regulating member 150 comprising a balance spring 44, a balance 41, a balance cock 42 and a bearing 43. The main body 2 of the stud-holder 120 is mounted on the balance cock 42 around the bearing 43. The balance 41 is located below the balance cock 42 and above the balance spring 44. The body 3 comprises a clamp for holding the stud.

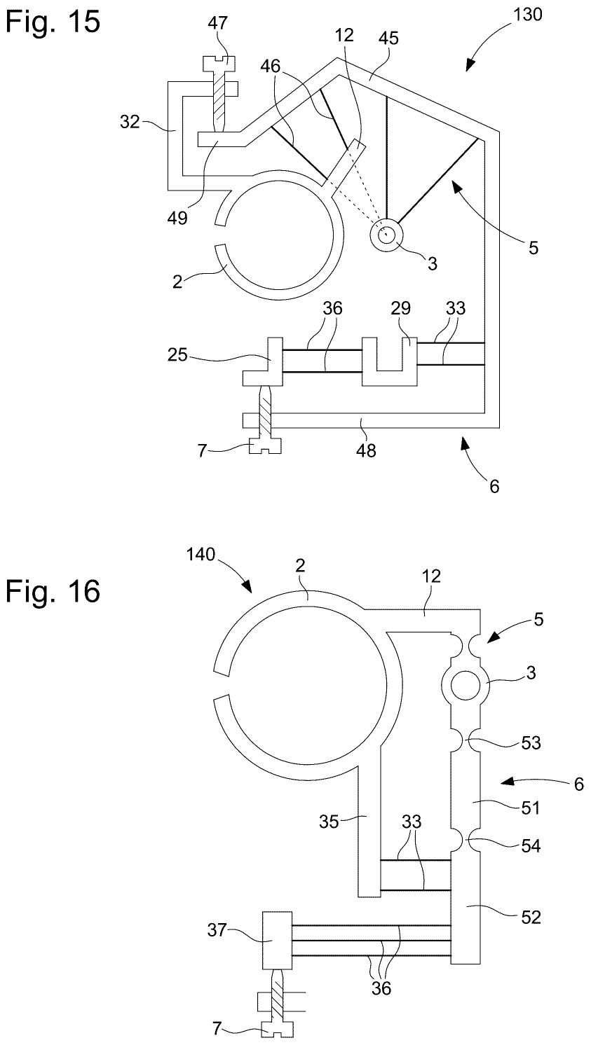

In the embodiment of the stud-holder 130 shown in FIG. 15, the prestressing means 6 are configured to allow the rate and the isochronism slope to be adjusted. The main body 2 comprises a first straight arm 12 and a second U-shaped arm 32.

The prestressing means 6 comprise a peripheral armature 45 partly surrounding the main body 2 and the secondary body 3, substantially describing the shape of a pentagon with one face missing. The peripheral armature 45 is connected to the secondary body 3 by a first pair of non-crossing flexible blades 16, and to the first straight arm 12 of the main body 2 by a second pair of flexible blades 46.

The prestressing means 6 are provided with a secondary blade 28 connected to the secondary body 3, as well as with a first L-shaped movable body 25 and a second U-shaped movable body 29. The secondary flexible blade 28 is connected to the inside of the U of the second movable body 29, which is oriented towards the secondary body 3.

The prestressing means 6 comprise two tertiary blades 33 and two quaternary blades 36 arranged in continuity with each other and perpendicularly to the secondary flexible blade 28 in the rest position of the prestressing means 6. The tertiary blades 33 connect the second movable body 29 to the peripheral armature, whereas the quaternary flexible blades 36 connect the second movable body 29 to the first movable body 25.

The prestressing means 6 comprise two screws. A first screw 7 is arranged through a first curved end 48 of the peripheral armature 45 to bear against the first movable body 25. A second screw 47 is arranged through the second arm 32 of the main body 2 to bear against a second end 49 of the peripheral armature 45.

The first screw 7 is used to modify the rate of the regulating member, whereas the second screw 47 is used to modify the isochronism slope of the regulating member.

More specifically, by actuating the second screw 47, the peripheral armature 45 rotates about a centre of rotation corresponding to the intersection between the second pair of flexible blades 46 and the secondary body 3. This rotation modifies the stiffness between the two non-crossing blades 16, in the same way as the embodiment shown in FIG. 12.

In the embodiment of the stud-holder 140 shown in FIG. 16, the flexible element 5 is a neck 8 similar to the stud-holder 10 shown in FIG. 2, and the prestressing means 6 are provided with a plurality of elongate rigid sections, in this case two rigid sections 51, 52, joined by flexible necks 53, 54. In the rest position, the rigid sections 51, 52 and the flexible necks 53, 54 are arranged substantially in a straight line.

In this embodiment, the flexible necks 53, 54 could be replaced by flexible blades of a similar length to the necks.

The prestressing means 6 are also provided with a spring formed by flexible blades, similar to the embodiment of the stud-holder 120 shown in FIG. 13. The tertiary flexible blades 33 and quaternary flexible blades 36 are connected to the second section 52 of the prestressing means 6.

By applying a variable displacement to the rigid movable body 37, the prestressing means 6 vary the stiffness of the flexible element 5. The force or torque is transmitted in part to the second rigid section 52, and to the flexible element 5 via the first rigid section 51, via the flexible necks 53, 54. The rate of the regulating member is thus varied.

It goes without saying that the invention is not limited to the embodiments of regulating members described with reference to the figures and alternatives can be considered without leaving the scope of the invention.

1. A stud-holder for a regulating member of a horological movement, the regulating member comprising an inertial mass, for example a balance, a balance spring comprising a strip wound about itself in several turns, and a balance cock, the stud-holder comprising a main body intended to be mounted on the balance cock, and a secondary body arranged at a distance from the main body and configured to suspend the balance spring, the regulating member comprising a flexible element connecting the main body to the secondary body, wherein the stud-holder comprises prestressing means for applying a variable force or torque to the flexible element in order to adjust the rate and/or isochronism slope of the regulating member.

2. The stud-holder according to claim 1, wherein the flexible element comprises two crossing flexible blades connecting the main body to the secondary body.

3. The stud-holder according to claim 2, wherein the two flexible blades are connected to one another at their intersection.

4. The stud-holder according to claim 1, wherein the flexible element comprises two non-crossing flexible blades connecting the main body to the secondary body.

5. The stud-holder according to claim 1, wherein the flexible element comprises a flexible neck connecting the main body to the secondary body.

6. The stud-holder according to claim 1, wherein the flexible element comprises a flexible blade connecting the main body to the secondary body.

7. The stud-holder according to claim 1, wherein the flexible element comprises two substantially parallel flexible blades connecting the main body to the secondary body in order to form a translation stage.

8. The stud-holder according to claim 1, wherein the main body comprises an arm to which the flexible element is assembled.

9. The stud-holder according to claim 1, wherein the flexible element is stiffer than the strip.

10. The stud-holder according to claim 1, wherein the torque or force is continuously adjustable thanks to the prestressing means.

11. The stud-holder according to claim 1, wherein the prestressing means comprise a movable lever arranged to bear against the flexible element.

12. The stud-holder according to claim 1, wherein the prestressing means comprise a spring connected to the secondary body and a first movable body for stretching or compressing the spring.

13. The stud-holder according to claim 12, wherein the spring comprises a secondary flexible blade.

14. The stud-holder according to claim 12, wherein the spring comprises a plurality of tertiary flexible blades connecting the main body to the first movable body.

15. The stud-holder according to claim 14, wherein the spring comprises a plurality of quaternary flexible blades connecting the first movable body to a second movable body of the prestressing means.

16. The stud-holder according to claim 1, wherein the prestressing means comprise a plurality of rigid sections connected by flexible necks or flexible blades.

17. A regulating member for a horological movement, the regulating member comprising a balance, a balance spring comprising a strip wound about itself in several turns, a balance cock, and the stud-holder according to claim 1.

18. A horological movement, comprising the regulating member according to claim 17.
